(19) United States
(12) Patent Application Publication
(10) Pub. No.: US 2017/0044974 A1
(43) Pub. Date: Feb. 16, 2017

(54) Outboard Motor of a Reciprocating Piston Internal Combustion Engine Type

(71) Applicant: Neander Motors AG, Kiel (DE)

(72) Inventor: Claus BRUESTLE, Nordheim (DE)

(21) Appl. No.: 15/235,165

(22) Filed: Aug. 12, 2016

(30) Foreign Application Priority Data
Aug. 13, 2015 (DE) 10 2015 010 549.3

(51) Int. Cl. F02B 61/04; F02F 7/00; F02B 75/00

(52) U.S. Cl. CPC F02B 61/045; F02B 75/007; F02F 7/0046; F16F 15/3153

(57) ABSTRACT

The outboard motor of the reciprocating piston internal combustion engine type has a crankshaft system with a crankshaft positioned upright within a machine housing of the internal combustion engine and having at an upper end region a flywheel. The flywheel is clad with a cover that extensively surrounds the flywheel starting at a top side of the internal combustion engine. Here, the crankshaft system has two parallel crankshafts that are each provided at their upper end regions with flywheels. The flywheels, when viewed in the axial direction of the crankshafts, are arranged offset with respect to each other and overlap in the manner of circular segments. The cover encapsulates the two flywheels over a significant range and is held in position on pivot axles of the flywheels.

### CROSS REFERENCE TO RELATED APPLICATIONS

This application claims priority under 35 U.S.C. §119 from German Patent Application No. 10 2015 010 549.3, filed Aug. 13, 2015, the entire disclosure of which is herein expressly incorporated by reference.

### BACKGROUND AND SUMMARY OF THE INVENTION

The invention relates to an outboard motor of the reciprocating piston internal combustion engine type, including a crankshaft system having at least one crankshaft positioned upright in a machine housing of the internal combustion engine.

An outboard motor unit is known from U.S. Pat. No. 5,163,394, which has a reciprocating piston internal combustion engine. This internal combustion engine features horizontal cylinders having reciprocating pistons operating within them that cooperate with an upright-positioned crankshaft, connecting rods being interposed therein. This crankshaft is provided at an upper end region with a flywheel, and it drives a camshaft via an endless belt drive. The flywheel and areas of the endless belt drive are covered by a cladding that runs underneath a cowl surrounding the outboard motor.

U.S. Pat. No. 3,750,615 describes an outboard motor that has an upright positioned drive shaft housing. Arranged adjacent to a top side of the drive shaft housing is a drive unit in the form of an internal combustion engine from which a shaft provided with a flywheel extends. The flywheel and the internal combustion engine are covered by a cladding that surrounds a bowl with a cover. Provided on the bowl is a connection piece that surrounds the driveshaft housing, a sealing element being interposed therein. The bowl is attached to a stud of a mounting fixture of the outboard motor by means of a screw. A horizontal arm extends above the flywheel.

U.S. Pat. No. 6,132,273 describes an outboard motor haying horizontal cylinders and a. vertically running crankshaft. The latter has at its upper end a flywheel that is clad with a flywheel cover. The outboard motor is essentially surrounded by a cowl structure that has an upper section and a lower section, The upper section is connected to the lower section via latch closures.

According to U.S. Pat. No. 5,370,563, a vertical crankshaft of an outboard motor has a flywheel. A cover for the flywheel extends underneath a wall of the motor cowl that encapsulates the outboard motor.

The object of the invention is to design a functional cladding for at least one flywheel of a flywheel device arranged at the upper end region of a crankshaft system, wherein the cladding is fixable to an outboard motor of the reciprocating piston internal combustion engine type via holding devices realizable by feasible measures.

According to the invention, this objective is achieved by an outboard motor of the reciprocating piston internal combustion engine type, including a crankshaft system positioned upright in a machine housing of the internal combustion engine. The crankshaft system has two parallel crankshafts that are each provided at their upper end regions with flywheels, The flywheels, when viewed in the axial direction of the crankshafts, are arranged offset with respect to each other and overlap in the manner of circular segments. The cover encapsulates the two flywheels over a significant range and is held in position on pivot axles of the flywheels.

The advantages principally achieved by the invention may be seen in the fact that the flywheels, which are joined to the crankshafts of the crankshaft system positioned upright in the machine housing and which are mounted in an upper region of the internal combustion engine, where the cladding of the flywheels, which can be installed with a service-typical effort, ensure efficient protection for persons close to the outboard motor is ensured—even when (and especially when) the cowl of the outboard motor is open and the flywheels are rotating. In this arrangement, the pivot axles of the crankshafts, which are firmly connected to the flywheels and pass through the latter in the axial direction, are used to attach the flywheels in an ideal manner. It is inventive that first and second holding devices for the cover, which surround connection sleeves, are operative between the casing wall of the cover surrounding the flywheels and the pivot axles of the flywheels. The connection sleeves are attached on one side to the casing wall and on the other side to the outer races of the roller bearings, the inner races of which are rotationally fixedly joined to the pivot axles of the flywheels. To support the latter, each connection sleeve at an upper end surrounds a first holding fixture for the casing wall and at a lower end has a second holding fixture for the outer race of the roller bearing. It should be emphasized that each pivot axle of the flywheels has an axle extension to hold the inner race of the roller bearing. It is exemplary that the axle extension has a nut to secure the flywheel axially, the inner race of the roller bearing being supported on the nut with at least one spacer element being interposed therein.

The standard is set by the solution in which—for the axial securing of the roller bearing inner race—the mounting screw is used that is screwed into an axial thread cut into the open side of the axle extension, a spacer ring being provided between the screw head of the mounting screw and the inner race of the roller bearing. Moreover, it is ideal for a holding device in the form of, for example, a retaining ring to be used to axially secure the connection sleeve to the casing wall. The holding device is operative between the connection sleeve and casing wall.

Finally, it contributes to the optimization of the connection sleeve if, between the top side of this connection sleeve d the casing wall, a mushroom-shaped cover element is provided, the latter being operatively connected on one side via a securing device to an inner wall of the connection sleeve and on the other side being supported on the casing wall with the annular lip.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a top view of an outboard motor of the reciprocating piston internal combustion engine type.

FIG. 2 is an oblique view from the top left rear side of the outboard motor according to FIG. 1.

FIG. 3 is a schematic illustration of flywheels of the outboard motor of the internal combustion engine type having a cover and a cowl surrounding this cover and the outboard motor.

FIG. 4 is a detail view X of FIG. 3 in a larger scale.

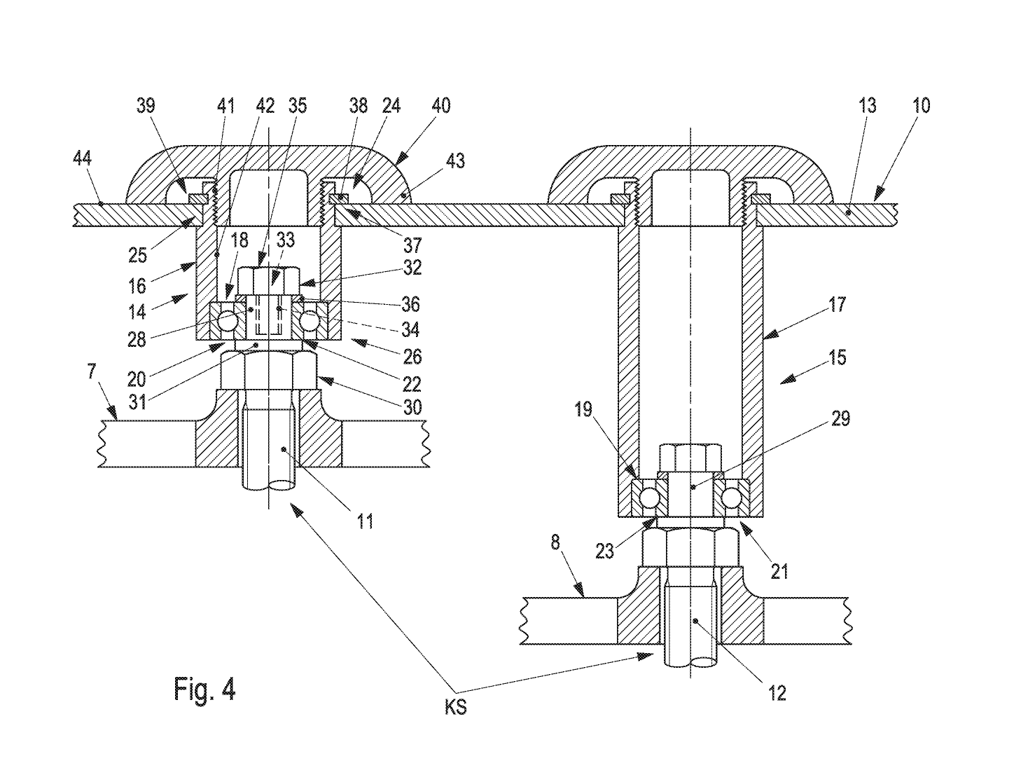

### DETAILED DESCRIPTION OF THE DRAWINGS

An outboard motor 1 of the reciprocating piston internal combustion engine type is used to drive a boat (not depicted). An internal combustion engine 2 has a crankshaft system KS comprising two crankshafts 3 and 4. The crankshafts 3 and 4 are positioned upright in a machine housing 5 and are furnished outside of the machine housing 5 and, in particular at the upper end regions 6 and 6′, with flywheels 7 and 8. Flywheels 7 and 8, when viewed in axial direction A-A of crankshafts 3 and 4, are arranged offset relative to each other, overlapping in the manner of circular segments. Crankshafts 3 and 4 are actuated via connecting rods (not depicted) by pistons that move back and forth within cylinders of the engine and drive a propeller operating below the water line, a transmission being interposed therein (DE 10 2012 015 907 B3).

Starting from a top side 9 of internal combustion engine 2, a cover 10 that is, for example, hinged or removable, encapsulates the two flywheels 7 and 8 over a significant range in the horizontal or vertical direction, C-C and B-B, respectively. In this arrangement, the cover 10 is detachably held in position on pivot axles 11 and 12 of flywheels 7 and 8, in order to implement this, first and second holding devices 14 and 15 that encapsulate connection sleeves 16 and 17 are provided between a casing wall 13 of cover 10 that surrounds flywheels 7 and 8 and pivot axles 11 and 12 of flywheels 7 and 8. The latter can be made of plastic, lightweight metal or the like and are attached on the one side to casing wall 13 and on the other side to outer races 18 and 19 of roller bearings 20 and 21. The inner races 22 and 23 of the roller bearings 20 and 21 are rotationally fixedly joined to pivot axles 11 and 12 of flywheels 7 and 8. Each connection sleeve, for example 16, has at an upper end 24 a first holding fixture 25 for casing wall 13 and at a lower end 26 a second holding fixture for outer race 18 of roller bearing 20. Pivot axles 11 and 12 of flywheels 7 and 8 are provided with axle extensions 28 and 29, which are designed to hold the inner races 22 and 23. Each axle extension, for example 28, has a nut 30 that axially secures the flywheel 7 and on which inner race 22 of roller bearing 20 is supported, at least one spacer element 31 being interposed therein.

To axially secure inner race 22 of roller bearing 20, a mounting screw 32 is used which is screwed into an axial thread 33 cut into the open side 33 of the axle extension 27. This solution is completed by arrangement of a spacer ring 36 between a screw head 35 of mounting screw 32 and inner race 22 of roller bearing 20. Connection sleeve 16 is secured in the axial direction against casing wall 13 via a holding device 37, e.g. in the form of a locking ring 38. The holding device 37 is operative between connection sleeve 16 and casing wall 13.

Moreover, a cover element 40 made of plastic, metal or another suitable material is mounted between an upper sleeve side 39 of connection sleeve 16 and casing wall 13. Cover element 40 is on one side in operative connection, for example, by frictional connection via a securing device 41, with an interior wall 42, and it braces on the other side with an annular lip 43 against an outer side 44 of casing wall 13.

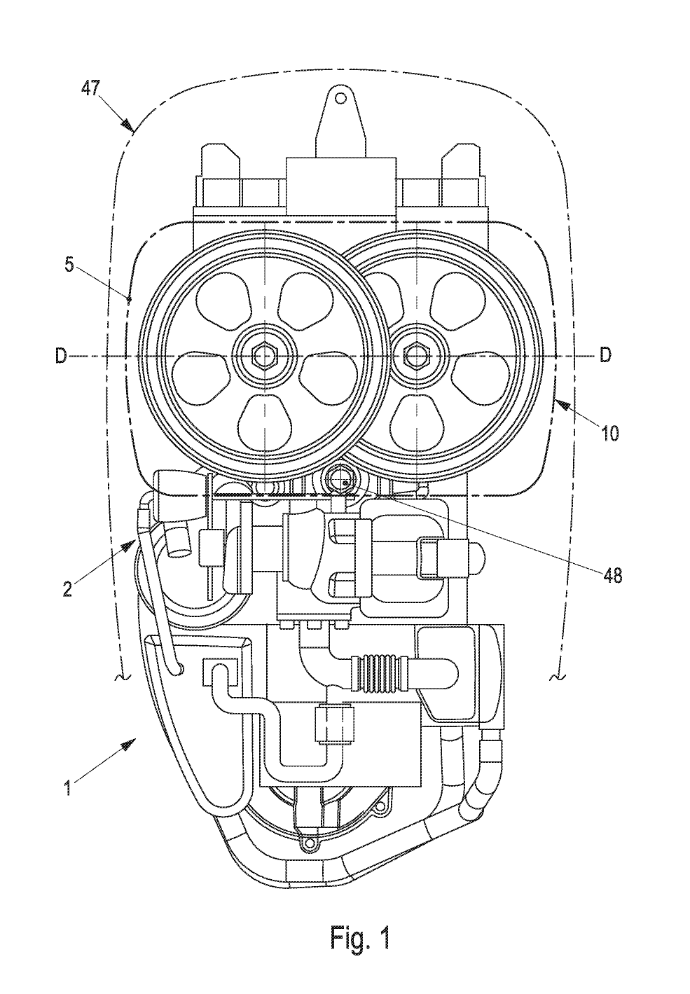

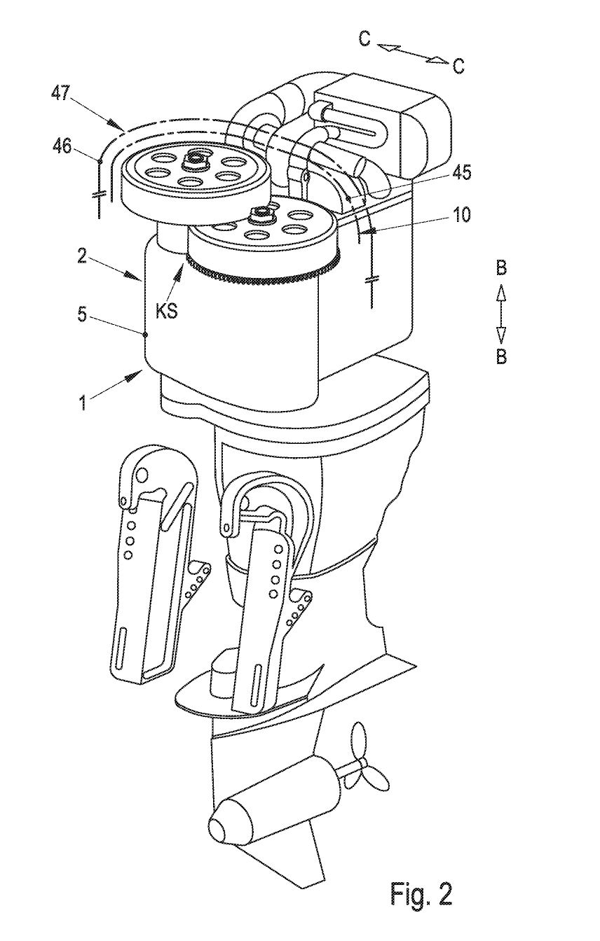

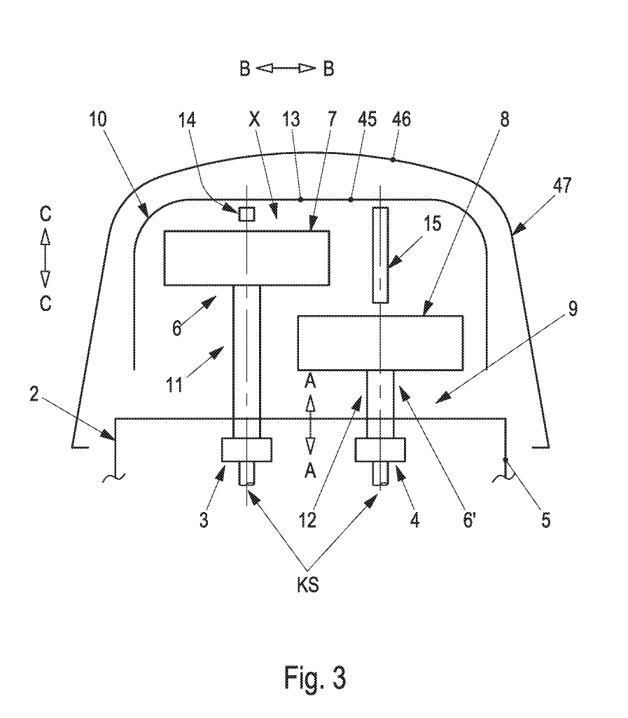

In FIGS. 2 and 3, mold lines 45 and 46 are depicted, generally showing a section along line D-D of FIG. 1. Mold line 45 goes with cover mold line 46 goes with a cowl 47 that wraps around the outboard motor 1, including cover 10. Moreover, cover 10 and cowl 47 are manufactured, for example, out of plastic, metal or the like.

Finally, FIG. 1 shows that cover 10 is held in position on machine housing 5 of internal combustion engine 1 by means of, for example, a screw 48.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An outboard motor of a reciprocating piston internal combustion engine type, the outboard motor comprising:
a crankshaft system having two parallel crankshafts positioned upright in a machine housing, each crankshaft being provided with a flywheel at an upper end region;
a cover configured to surround the respective flywheels, wherein
the flywheels, when viewed in an axial direction of the two parallel crankshafts, are arranged offset with respect to one another and overlap in a manner of circular segments, and
the cover surrounding the flywheels is held in position on pivot axles of the flywheels.

2. The outboard motor according to claim 1, further comprising:
first and second holding devices for the cover, the first and second holding devices respectively surrounding first and second connection sleeves and are operative between a casing wail of the cover surrounding the flywheels and the pivot axles of the flywheels, wherein
the connection sleeves are attached on one side to the casing wall and on the other side to outer races of roller bearings, inner races of the roller bearings being rotationally fixedly connected to the pivot axles of the flywheels.

3. The outboard motor according to claim 2, wherein each connection sleeve has at an upper end, a first holding fixture for the casing wall and, at a lower end, a second holding fixture for the outer race of the roller bearing.

4. The outboard motor according to claim 2, wherein each pivot axle of the flywheels surrounds an axle extension for holding the inner race of the roller bearing.

5. The outboard motor according to claim 4, wherein the axle extension has a nut that axially secures the flywheel, on which nut the inner race of the roller bearing is supported with interposition of at least one spacer element.

6. The outboard motor according to claim 5, wherein a mounting screw, which is screwed into an axial thread cut into an open side of the axle extension, serves to axially secure the inner race of the roller bearing.

7. The outboard motor according to claim 6, wherein a spacer ring is provided between a screw head of the mounting screw and the inner race of the roller bearing.

8. The outboard motor according to claim 2, further comprising:
a holding device in the form of a locking ring that serves to axially secure the connection sleeve against the casing wall, the holding device being operative between the connection sleeve and the casing wall.

9. The outboard motor according to claim 2, wherein a cover element is provided between an upper sleeve side of the connection sleeve and the casing wall.

10. The outboard motor according to claim 9, wherein the cover element is, on one side, in operative connection with an interior wall of the connection sleeve by frictional connection via a securing device and, on the other side, braces with an annular lip against the casing wall.
